(19) United States
(12) Patent Application Publication
(10) Pub. No.: US 2005/0123759 A1
(43) Pub. Date: Jun. 9, 2005

(54) Additive-coated resin and method of making same

(76) Inventors: Roger Weinberg, Akron, OH (US); Oleg V. Kozyuk, Westlake, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/727,388

(22) Filed: Dec. 4, 2003

(51) Int. Cl. B32B 5/16; B05D 3/12

(52) U.S. Cl. 428/403; 428/407; 427/212; 427/331

(57) ABSTRACT

A resin for use in molding, sintering, or extruding finished parts, the resin comprising a plurality of polymeric particles and a coating of at least one additive covering each of the polymeric particles. The method of preparing the resin comprises the steps of combining at least one additive, a plurality of polymeric particles, and at least one liquid to form a suspension; and removing at least a portion of the liquid from the suspension to thereby form at least a partial additive coating on each polymeric particle.

### BACKGROUND

A wide variety of particulate additives are used in combination with virgin resins in order to improve the properties of the virgin resin and/or the utility of the finished products formed from such combination of additive(s) and virgin resin(s). A virgin resin can be any polymerized or composite plastic or elastomer that is received by a compounder for further processing. Numerous methods for introducing additives to virgin resins are known to those skilled in the art. For example, additives (in either pellet or powder form) can be dry compounded with virgin resin (in powder, pellet, bead, or pillow block form). Dry compounding includes mixing the virgin resin with a dry additive, usually in the form of a powder, in a blender or other type of mixer. During mixing, heat is created from the frictional shear forces and melts the outer surface of the virgin resin. The additive then mixes with the melted surface of the virgin resin and embeds itself therein.

One issue with dry compounding is that a portion of the virgin resin (i.e., the outer surface) is no longer “virgin” because that portion has already been taken to its melt index during the dry compounding process. Thus, some of the properties of the virgin resin may be degraded.

Another issue with dry compounding is the fact that many of the additive suppliers cannot deliver anything beyond an agglomerated composite. On the other hand, nano-composite additive suppliers have to deal with the fact that conventional plastics compounding machinery may not accept, or maximize the benefit, of the form in which the nano-composite additive is delivered. Thus, delivering a de-agglomerated additive to the compounder does not necessarily mean that it will remain de-agglomerated when introduced to the virgin resin. For example, conventional conductive carbon suppliers may claim the delivery of a powdered material having a base particle size of 15-50 nanometers. While the manufactured base particle size is actually nano-metric, the carbon powder is delivered in a form containing particle agglomerates in a wide distribution range many times containing over 1000 micron agglomerates. Maximizing the benefit of conductivity in a “plastic” can only be achieved if the particles are both de-agglomerated and uniformly dispersed into the virgin polymer. In this way, less material can accomplish greater conductivity at lower carbon loadings. The virgin resin, having less carbon additive, will also retain more of the original polymer properties.

In another example, pigments that are de-agglomerated and dispersed uniformly can produce improved color strength, less “color splay,” and “swirling.” Again lower loadings can aid the performance of the compounded “plastic”. Yet, in most cases when these nano-structured additives are measured in the final extruded parts, the particles of additive are so agglomerated as to be visible by eye, with aggregate sizes greater than 50 microns. This means that micro and nano-materials are either agglomerated at delivery or are agglomerating during compounding, or both.

Another exemplary method of introducing additives to virgin resins includes melt compounding the additives with virgin resin using a heated mixer, heated extruder, or other suitable melt blending apparatus to form a “composite resin” that is ready for end use processing (e.g., fabrication of finished plastic components). By changing the loading concentrations and the physical surface characteristics of the additive packages, properties of the virgin polymers can also be altered.

Yet another method of introducing additives to virgin resins is to contact such particles with an additive at the extruder hopper during end use processing, but before melt compounding or extrusion. At this stage, the additives are usually introduced to the virgin resin in liquid concentrate form. In many instances, difficulty is encountered in metering the exact amounts of additive concentrate necessary to do a specific job. This is especially true for additives such as processing aids and external lubricants, which are used at very low levels and usually, cannot be added in a concentrate form.

Yet another exemplary method of introducing additives to virgin resins, particularly polypropylene granules, includes dispersing the additives in a solvent thereby dissolving both the virgin resin and additives followed by the removal of the solvent. While some stabilization is imparted to the polypropylene granules, the treated pellets have severe static electricity problems during processing and the virgin resin has been altered from its original properties by adsorbing some of the chemical properties of the solvent carbon chains.

### DETAILED DESCRIPTION

The present invention is directed to an additive coated resin for use in molding or extruding finished parts and a method for making the additive coated resin. The additive-coated resin comprises a plurality of polymeric particles each having at least a partial coating of at least one additive surface covering each of the polymeric particles. The additive(s) can be used to improve the properties of the polymeric particles and/or the utility of the finished parts formed from such resin via numerous “end use” processes such as injection molding, rotational injection molding, blow molding, extruding, and sintering.

The polymeric particles used in the additive-coated resin may be selected from a variety of polymeric materials that can be natural, synthetic, or a combination thereof. Suitable polymeric materials include, but are not limited to, polystyrenes, polypropylenes, polysulphones, polyacrylates, polyamides, polyimides, polyesters, polyethylenes, polyvinyls, polycarbonates, polybutadienes, elastomers, rubber, and combinations thereof. In one embodiment, the polymeric material can be in “virgin” form (also can be referred to as “virgin resin”). The term “virgin resin” as used herein can refer to a polymeric or elastomeric material has not been subjected to internal chemical property changes or processing other than that required for it's initial manufacture. In another embodiment, the polymeric material can be a composite polymer, which is a mixture of a virgin polymer and an additive.

The term “polymeric particles” as used herein can refer to any polymeric material in unconsolidated form. Non-limiting examples of polymeric particles include the polymeric material in powder, pellet, bead, or pillow block form. As used herein, the terms “polymeric particles”, “polymeric nuggets”, “polymeric slivers”, “polymeric chunks”, “polymer fluff” and “resin” may be used interchangeably.

The additive used in the additive-coated resin may be selected from a variety of additives. Suitable additives include, but are not limited to, antioxidants, processing aids, slip agents, anti-blocking agents, antistatic agents, lubricants, UV stabilizers, coupling agents, colorants, pigments, dyes, fire retardants, cycle enhancers, electrically conductive materials, blowing agents, organic crystals, inorganic crystals, dielectrics, metals, mixed metals, metal oxides, mixed metal oxides, minerals, non-woven fibers, flavorants, scent extracts, anti-microbial agents, trace elements, plant tissues, animal tissues, proteins, and combinations thereof.

In one embodiment, a thickness of the additive coating is equal to or greater than a thickness of an average basic particle size of the additive(s). In another embodiment, the additive coating can cover an entire surface area of the polymeric particle to form a layer of additive on each polymeric particle. Of course, it will be appreciated that the additive coating can include multiple layers of the additive(s). Alternatively, the additive coating can cover a portion of the surface area of the polymeric particle to form a partial layer of coating on each polymeric particle.

In the processing of the additive coated resin, the process can include the following steps: combining a plurality of polymeric particles, at least one additive, and at least one liquid (collectively can be referred to as “the ingredients”) to form a suspension, and removing at least a portion of the liquid to thereby form an additive coating on each of the polymeric particles. It will be appreciated that the ingredients that form the suspension can be combined in any order. While not wishing to be bound by theory, the additive can be bonded to the surface of the polymeric particles via electrostatic, molecular adhesion, chemical binder “carrier” adhesion, or any combination of these, to form the additive coating on the surface(s) of each polymeric particle.

In one embodiment, a carrier or complimentary additive may be combined with the polymeric particles, additive(s), and at least one liquid(s) to form the suspension. The carrier or complimentary additives can be used to assist in bonding the additive(s) to the surface of the polymeric particles via a chemical or chemical interaction with the additive(s), the polymeric particles, or both. Suitable carriers or complimentary additives can include, for example, low density polymers, low density monomers, oils, rubbers, polyols, plant extracts, animal extracts, acids, fillers, waxes, surfactants, dispersants, and any combinations thereof. It will be appreciated that even though the addition of a carrier or complimentary additive can improve the bonding of the additive particles to the polymeric particles, the resulting additive-coated resin may include unwanted impurities resulting from the carrier or complimentary additive.

The liquid used in the process described above can be any liquid that has compatible characteristics between the additive used and the polymeric particles used such that the liquid can assist in the process of surface bonding the additive to the polymeric particles. Suitable liquids that can be used include, but are not limited to, water, organic and/or inorganic solvents, cryogenic liquids, super-critical fluids, animal extract oils, plant extracts, and combinations thereof.

In one embodiment, the components that comprise the suspension (i.e., the polymeric particles, additive(s), and liquid(s)) can each be present in the suspension in a wide variety of weight ranges. As evidenced by the wide ranges, the amounts can vary depending on the type of polymer, additive, and liquid selected (because of the different densities of each) as well as the average basic particle size of the polymer and additive selected.

In one embodiment, the liquid can be removed from the suspension by changing conditions of the suspension, such as temperature and/or pressure, using conventional liquid removal procedures. For example, the suspension can be heated to evaporate the remaining liquid. If the suspension is heated to evaporate the liquid, it will be appreciated that the suspension should be heated to a temperature less than the melting point index of the polymeric particle to prevent unwanted melting of the polymeric particle and to preserve the “virgin” status of the polymer, if applicable. In another example, a vacuum can be applied to the suspension to remove the remaining liquid. It will be appreciated that other conventional liquid removal processes can be used to remove the liquid such as filtration and desiccation.

In one embodiment, the suspension can be kept in motion to assist in the formation of a uniform coating around each polymeric particle. For example, the suspension can be kept in motion by agitation, vibration, sonication, cetrifugation, dispersion, attrition, and rolling. It will be appreciated that other means can be used to keep the suspension in motion. The suspension can be kept in motion after the polymeric particles, additive(s), and liquid(s) have been combined together and/or during the removal of at least a portion of the liquid(s). While not wishing to be bound by theory, it has also been recognized that keeping the suspension in motion can assist in de-agglomerating the additive particles.

In one embodiment, the performance characteristics of the additive coated resin, which can be exhibited in both the finished manufactured goods and post-coating compounding steps, can be improved by reducing the size of the average additive particle agglomerates. The reduction of the size of the average additive particle agglomerates permits more additive particle agglomerates to occupy the surface area of the polymeric particle based on generally accepted geometrical principles.

In one embodiment, the additive(s) can be de-agglomerated prior to introduction into the suspension using any one or combination of techniques including particle reduction by mechanical, chemical or physical processes. Suitable particle reduction techniques include, but are not limited to, hydrodynamic cavitation, homogenization, media milling, pulverization, exfoliation, dissolution, precipitation, crystallization, explosion, and sublimation.

In one embodiment, the process described above can de-agglomerate the additive particles once the ingredients are in suspension. For example, an additive, before being combined with the polymeric particles and the liquid, can have an average particle size of about 500 nanometers and particle agglomerates with 90% of the particle agglomerates at or above 400 microns. Once combined together with the polymeric particles and the liquid to form the suspension, the suspension can be kept in motion to thereby reduce or de-agglomerate the average additive particle agglomerates to 100 microns. Thus, the process described above can reduce the size of the additive particles and, thus, provide more additive particle agglomerates to occupy the surface area of the polymeric particle.

The additive-coated resin resulting from the process described above can provide several benefits to the industry. First, the additive-coated resin can provide for a more uniform and thorough dispersion of the additive in finished parts. Second, no portion of the underlying polymeric particles of the additive coated resin have a melt history due to the fact that the suspension is not heated at a temperature greater than the melt index of the polymeric particles to be coated. Third, the additive-coated resin can act as a barrier to excessive moisture absorption. Fourth, the additive-coated resin can reduce “recovery” and/or mix times in post-compounding steps. Finally, the additive-coated resin can achieve desirable results, while using less additive in the process of making such additive coated resin.

The present invention is further described by the following non-limiting examples. The examples are merely illustrative and do not in any way limit the scope of the present invention as described and claimed.

### EXAMPLE 1

Carbazole violet pigment in powder form, having a mean average particle size of 14 microns, was dispersed into propanol and tetrahydrofuran at room temperature to form a dispersion. Polyetheylene tetrathalate (PET) pellets were then added to the dispersion at room temperature to form a suspension containing 0.1 wt % carbazole violet particles to the weight of the PET pellets. The suspension was kept in motion through mechanical mixing, while the temperature of the suspension was elevated to below the melting temperature of the carbazole violet pigment and the PET pellets to evaporate the propanol and tetrahydrofuran. After about 7 minutes, the propanol and tetrahydrofuran evaporated and the carbazole violet particles were bonded to the surface of the PET pellets forming carbazole violet coated PET pellets that are 0.1% weight loaded with carbazole violet.

The carbazole violet coated PET pellets were then placed under a “transmitted light” microscope to measure the mean average particle size of the carbazole violet pigment coated on the surface of the PET pellets. The mean average particle size of the carbazole violet pigment was measured at 260 nanometers. Thus, the mean average particle size of the carbazole violet pigment was reduced from 14 microns to 260 nanometers during the process.

The carbazole violet coated PET pellets were then used in a single screw blow molding machine to mold cosmetic bottles. When compared to cosmetic bottles molded from PET pellets combined with a 5% concentrate powder additive of a well known colorant supplier (“concentrate and PET pellet combination”), the cosmetic bottles molded from 0.1% weight loaded carbazole violet coated PET pellets (“additive coated resin”) showed improvement in ramp-up time, recovery time, color opacity, and additive residuals.

Regarding ramp-up time, using the concentrate and PET pellet combination, the blow molding machine had to produce 150 cosmetic bottles, which took about 3 minutes and 45 seconds, before yielding an acceptable color. When using the additive-coated resin, the blow molding machine had to produce only 25 cosmetic bottles, which took about 37.5 seconds, before yielding an acceptable color. Regarding screw “recovery time,” the number of “shots” per minute (i.e, the cosmetic bottle production rate) increased by 16% when using the additive-coated resin versus the concentrate and PET pellet combination. Regarding color opacity, the color “stay” or stability from the beginning of the run to the end of the run using the additive-coated resin was a significant improvement over the concentrate and PET pellet combination. In fact, when the additive-coated resin was used, adjustments to control the coloring were not required during the run. Finally, the amount of additive remaining in the extruder (i.e, residual) after the run with the additive-coated resin was less than the amount of additive remaining in the extruder after the run with the concentrate and PET pellet combination.

### EXAMPLE 2

The process of Example 1 was repeated and included the same components, except that the suspension of carbazole violet particles, PET pellets, propanol, and tetrahydrofuran contained 20 wt % carbazole violet particles to the weight of the PET pellets. After about 7 minutes, the propanol and tetrahydrofuran evaporated and the carbazole violet particles were bonded to the surface of the PET pellets forming carbazole violet coated PET pellets that are 20% weight loaded with carbazole violet.

### EXAMPLE 3

The process of Example 1 was repeated and included the same components, except that polyethylene wax particles were added to the dispersion at 0.1% weight loading with polyethylene wax. The resulting bond of the carbazole violet coating to the surface of the PET pellets created greater rub-up resistance than the carbazole violet coated PET pellets from Example 1 when the coated PET pellets were dragged across the surface of paper with a 2 pound load.

### EXAMPLE 4

The process of Example 1 was repeated and included the same components, except that polyethylene wax particles were added to the dispersion at 20% weight loading with polyethylene wax. The resulting bond of the carbazole violet coating to the surface of the PET pellets created greater rub-up resistance than the carbazole violet coated PET pellets from Example 2 when the coated PET pellets were dragged across the surface of paper with a 2 pound load.

### EXAMPLE 5

In one experiment, standard packaged conductive carbon, having an average base particle size of 30 nanometers and containing agglomerated powder with 90% of particles at or above 350 microns, was dispersed in water at or near room temperature to form a dispersion. Polypropylene beads were then added to the dispersion at room temperature to form a suspension containing 1.0 wt % of the conductive carbon to the weight of the polypropylene beads. When in suspension, the standard packaged conductive carbon showed average agglomerates at above 350 microns. The suspension was kept in motion through mechanical mixing. The water was then removed at or near room temperature by vacuum, while the suspension remained in motion. After about 48 minutes, the water was removed and the conductive carbon particles were bonded to the surface of the polypropylene beads forming conductive carbon coated polypropylene beads (“test beads 1”).

In another experiment, de-agglomerated (particle reduced) conductive carbon, having an average basic particle size under 400 nanometers, was dispersed in water at or near room temperature to form a dispersion. Polypropylene beads were then added at or near room temperature to the dispersion at room temperature to form a suspension containing 1.0 wt % of the conductive carbon to the weight of the polypropylene beads. The suspension was kept in motion through mechanical mixing. The water was then removed at or near room temperature by vacuum, while the suspension remained in motion. After about 53 minutes, the water was removed and the conductive carbon particles were bonded to the surface of the polypropylene beads forming conductive carbon coated polypropylene beads (“test beads 2”).

In one experiment, test beads 1 and test beads 2 were then molded into test plaques resulting in test plaque 1 and test plaque 2, respectively. A Keithley Pico meter was then used to measure the resistivity at 500 volts of test plaque 1 and test plaque 2. The resistivity of test plaque 1 was 55×10⁹ ohms per square surface inch compared to 45×10⁹ ohms per square surface inch for test plaque 2. When compared to melt compounded resins, both the test plaques 1 and 2 yielded improved results. In order to achieve similar results as test plaques 1 and 2 (e.g., a resistivity of at least 55×10⁹ ohms per square surface inch), typical industry melt compounded resins require between 5% and up to 15% weight loading of conductive carbon.

In another experiment, test beads 2 (approximately 10 wt %) and virgin polypropylene beads (approximately 90 wt %) were molded into a test plaque resulting in test plaque 3 that included about 0.1% carbon loading. When compared with test plaque 1 regarding resistivity, both test plaques (i.e., 1 and 3) yielded 55×10⁹ ohms per square surface inch. Thus, the teat plaque 3, having ten times less carbon, yielded similar results as the test plaque 1.

Additionally, when test plaques 1 and 2 were compared to each other in terms of color strength, the increase in color strength of test plaque 2 was highly visible to the naked eye. When compared to melt compounded resins having similar carbon contents, both the test plaques 1 and 2 yielded improved color strength.

### EXAMPLE 6

Inorganic yellow pigment, a volcanic ash based cycle enhancer, a magnesium based talc filler and a low density polyethylene wax were dispersed in liquid hexane at room temperature to form a dispersion. Fluorinatedethylenepropylene (FEP) beads were then added to the dispersion at room temperature to form a suspension. The suspension contained 0.1 wt % of all the additive constituents (i.e., yellow pigment, volcanic ash based cycle enhancer, magnesium based talc filler and low density polyethylene wax) to the weight of the FEP beads. The suspension was kept in motion through mechanical mixing, while the temperature of the suspension was elevated to below the melting temperature of all the additive constituents to evaporate the liquid hexane. After about 9 minutes, the remaining liquid hexane evaporated and the additive constituents were bonded to the surface of the FEP beads forming additive coated FEP beads.

The additive-coated FEP beads were then extruded by a manufacturer into a thin “tape” used in the wire coating industry for identification and resistive properties, specifically for wrapping fiber-optic bundles. Apparently, any inconsistencies in the tape, such as agglomerates, cracks, and changes in concentrations of additives, can distract or interfere with the signals being transmitted electronically in the fiber optic bundles. The tape exhibited very uniform properties of visible reflection of color and undamaged physical polymer properties, such as compression, tensile, and elasticity strength otherwise reduced by multiple melt history and non-uniform particle introduction or “spotting”. The tape exhibited the following characteristics: improved uniform dispersion, lower additive necessary to achieve acceptable performance, and no melt history. The uniform dispersion allows for simplification of batch-to-batch consistency matching. The lower concentrations of additive combined with reduced melt history allows the FEP (which is otherwise sensitive to compounding) to retain more of it's virgin properties, such that the tape is less brittle and fewer visible agglomerates can cause resistive “hot spots”.

### EXAMPLE 7

Cobalt oxide pigment, having an average pre-processed pigment particle size of about 60 microns, was dispersed in liquid hexane at room temperature to form a dispersion. Cryogenically ground nylon powder was then added to the dispersion at room temperature to form a suspension. The suspension contained 1.2 wt % of the cobalt oxide pigment and 0.25% low-density polyethylene to the weight of the cryogenically ground nylon powder. The suspension was kept in motion through mechanical mixing, while the temperature of the suspension was elevated to below the melting temperature of the nylon powder to evaporate the liquid hexane. After about 15 minutes, the remaining liquid hexane evaporated and the cobalt oxide pigment was bonded to the surface of the cryogenically ground nylon powder forming cobalt oxide coated nylon powder.

In general, ground virgin polymeric particles are used in powder form for rotational molding, sintering, and applications requiring very rapid melt of the polymers because pellets or chunks take too long. In the case of the aforementioned example, the cobalt oxide coated nylon powder was molded into finished parts. When compared to finished parts molded from traditional nylon pellets and standard powdered concentrate blends, the finished parts molded from the cobalt oxide coated nylon powder exhibited improved uniformity of the cobalt oxide in the finished parts. In fact, the process above was repeated with nylon pellets instead of nylon powder, and the finished parts exhibited improved uniformity of the cobalt oxide in the finished parts. Thus, the additional process step of cryogenically grinding the pellets to form the nylon powder can be eliminated and reduce the overall cost of the finished parts.

### EXAMPLE 8

Laser welding of plastic can significantly reduce both a manufacturer's energy consumption as well as raw material supply needed to assemble a durable good. Consider the shear number of hose clamps used to hold plastic or rubber tubing and ductwork together. Each clamp also requires the additional material for the “nipple” or extension manifold for the clamp to slide over. By laser welding plastic parts together, both the clamp and the extra plastic can be eliminated as well as any glue. However, laser spectrum absorbable colorants and additives have proven to be prohibitive partners for many plastics because traditional operations cannot control the physical properties of the additives during compounding. For example, no dark colored polymeric finished parts that absorb the majority of laser light in the wavelength transmitted between about 800 to 1,100 nanometers are conducive to laser welding processes. Similarly, very light colored or clear polymeric finished parts that will not absorb a certain percentage of the same wavelengths are not conducive to laser welding. Accordingly, one possible solution was to make one surface partially transmissive, and the other mating surface partially absorptive and, thus, creating the optimal heating properties for the mating surfaces to melt into each other and fuse.

By using the process described above, an additive-coated resin can be produced from otherwise laser transmitting or absorbing compounds to form finished parts that are laser weldable. For example, laser weldable plastics and elastomers made by the process described above can have acceptable levels of transmissivity or absorptivity with plastic to plastic, elastomer to elastomer, and elastomer to plastic welding materials.

To form an additive-coated resin that will be the absorptive component, 0.5% weight percent of a mineral-based black colorant, having a pre-processed particle size of about 1 micron and a normal absorption of laser transmitted light in the 800 to 1,100 nanometer wavelengths, was combined with hexane to form a dispersion. Spherical beads of polypropylene, normally 80-95% transmissive to laser equipment in virgin form, were added to the dispersion to form a suspension. The suspension was kept in motion through mechanical mixing, while the temperature of the suspension was elevated to below the melting temperature of the polypropylene beads to evaporate the liquid. After about 30 minutes, the black colorant was bonded to the surface of the polypropylene beads to form black colorant coated polypropylene beads. The resulting black colorant coated polypropylene beads were not significantly transmissive in the laser's wavelengths. The black colorant coated polypropylene beads were then used to mold an automotive manifold where the manifold was the absorptive component.

To form an additive-coated resin that will be the transmissive component, 0.1% weight percent of an organic-based black colorant, having a pre-processed particle size of about 1 micron and post-processed size of about 350 nanometers, was combined with hexane to form a dispersion. Spherical beads of Santoprene®, a thermoplastic elastomer (TPE) manufactured by Advanced Elastomer Systems, were added to the dispersion to form a suspension. “Natural” or virgin Santoprene®, without colorant, is not very transmissive, usually around 35% to the laser wavelengths. The suspension was kept in motion through mechanical mixing, while the temperature of the suspension was elevated to below the melting temperature of the Santoprene® beads to evaporate the liquid. After about 30 minutes, the black colorant was bonded to the surface of the Santoprene® beads to form black colorant coated Santoprene® beads and the transmissivity of the black colorant coated Santoprene® beads remained above 20%, which can be still effective for welding. The black colorant coated Santoprene® beads were then used to mold a part that mates with the manifold (“the mating part”) where the mating part is the transmissive component.

The manifold and the mating part were then successfully welded together in the 980-1100 nanometer welding spectrum and the finished welded assembly (i.e., the manifold and the mating part) was approved by an automotive supplier for use in a future automotive project.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. An additive coated resin for use in molding, sintering, or extruding finished parts, the resin comprising:
a plurality of polymeric particles; and
a coating of at least one additive covering at least a portion of each of the polymeric particles.

2. The resin of claim 1 wherein the polymeric particles are in a form selected from the group consisting of powder, beads, pellets, pillow blocks, and any combinations thereof.

3. The resin of claim 1 wherein the polymeric particles includes a polymeric material, wherein the polymeric material is selected from the group consisting of a polystyrene, polypropylene, polysulphone, polyacrylate, polyamide, polyimide, polyester, polyethylene, polyvinyl, polycarbonate, polybutadiene, elastomers, rubber, and any combinations thereof.

4. The resin of claim 1 wherein the polymeric particles are virgin polymeric particles.

5. The resin of claim 1 wherein the additive is selected from the group consisting of an antioxidant, processing aid, slip agent, anti-blocking agent, antistatic agent, lubricant, UV stabilizer, coupling agent, colorant, pigment, dye, fire retardant, cycle enhancer, electrically conductive material, blowing agent, organic crystal, inorganic crystal, dielectric, metal, mixed metal, metal oxide, mixed metal oxide, mineral, non-woven fiber, flavorant, scent extract, anti-microbial agent, trace element, plant tissue, animal tissue, protein, and any combinations thereof.

6. The resin of claim 1 wherein the coating further includes a complimentary additive, wherein the complimentary additive is selected from the group consisting of a low density polymer, low density monomer, oil, rubber, polyol, plant extract, animal extract, acid, filler, natural wax, and any combinations thereof.

7. The resin of claim 1 wherein a thickness of the coating is equal to or greater than a diameter of an average basic particle size of the additive.

8. The resin of claim 1 wherein the coating covers all surfaces of each polymeric particle thereby forming a layer of the additive on each polymeric particle.

9. The resin of claim 8 wherein the coating includes multiple layers of the additive on each polymeric particle.

10. The resin of claim 1 wherein each polymeric particle is unmodified with respect to meeting its melt index.

11. The resin of claim 1 wherein no portion of each polymeric particle includes a melt history.

12. A method of preparing an additive coated resin for use in molding, sintering, or extruding finished parts, the method comprising the steps of:
combining at least one additive, a plurality of polymeric particles, and at least one liquid to form a suspension; and
removing at least a portion of the liquid from the suspension to thereby form at least a partial additive coating on each polymeric particle.

13. The method of claim 12 further comprising the step of keeping the suspension in motion during the combining step.

14. The method of claim 13 wherein the at least one additive is de-agglomerated after the combination step.

15. The method of claim 12 further comprising the step of keeping the suspension in motion during the removing step.

16. The method of claim 12 wherein at least 75% of the liquid is removed.

17. The method of claim 15 further comprising removing a remaining portion of the liquid to dry the polymeric particles and thereby form the additive coating on each polymeric particle.

18. The method of claim 12 wherein the removing step is accomplished by changing conditions of temperature and/or pressure of the suspension.

19. The method of claim 12 wherein the removing step is accomplished by heating the suspension to evaporate the liquid.

20. The method of claim 12 wherein the removing step is accomplished by vacuum.

21. The method of claim 12 wherein the polymeric particles are in a form selected from the group consisting of powder, beads, pellets, pillow blocks, and any combinations thereof.

22. The method of claim 12 wherein the polymeric particles includes a polymeric material, wherein the polymeric material is selected from the group consisting of a polystyrene, polypropylene, polysulphone, polyacrylate, polyamide, polyimide, polyester, polyethylene, polyvinyl, polycarbonate, polybutadiene, elastomers, rubber, and any combinations thereof.

23. The method of claim 12 wherein the additive is selected from the group consisting of an antioxidant, processing aid, slip agent, antiblocking agent, antistatic agent, lubricant, UV stabilizer, coupling agent, colorant, pigment, dye, fire retardant, cycle enhancer, electrically conductive material, blowing agent, organic crystal, inorganic crystal, dielectric, metal, mixed metal, metal oxide, mixed metal oxide, mineral, non-woven fiber, flavorant, scent extract, anti-microbial agent, trace element, plant tissue, animal tissue, protein, and any combinations thereof.

24. The method of claim 12 further comprising the step of adding a complimentary additive to the suspension, wherein the complimentary additive is selected from the group consisting of a low density polymer, low density monomer, oil, rubber, polyol, plant extract, animal extract, acid, filler, wax, surfactant, dispersant, and any combinations thereof.

25. A method of preparing an additive coated resin, the method comprising the steps of:
combining at least one additive and at least one liquid to form a dispersion;
adding a plurality of polymeric particles to the dispersion to form a suspension; and
removing at least a portion of the liquid from the suspension to thereby form an additive coating on each polymeric particle.

26. The method of claim 25 further comprising the step of keeping the suspension in motion during the combining, adding, and removing steps.

27. A method of preparing an additive coated resin, the method comprising the steps of:
adding a plurality of polymeric particles to a dispersion of at least one additive in at least one liquid to form a suspension; and
removing at least a portion of the liquid from the suspension to thereby form at least a partial additive coating on each polymeric particle.
